(19) United States
(12) Patent Application Publication
(10) Pub. No.: US 2003/0210697 A1
(43) Pub. Date: Nov. 13, 2003

(54) Auto encapsulation detection

(76) Inventor: Mathieu Mercier, St-Leonard (CA)

Correspondence Address: OGILVY RENAULT, 1981 MCGILL COLLEGE AVENUE, SUITE 1600, MONTREAL, QC, H3A2Y3, CA

(21) Appl. No.: 10/400,411

(22) Filed: Mar. 28, 2003

Related U.S. Application Data
(63) Continuation-in-part of application No. PCT/CA00/01127, filed on Sep. 29, 2000.

(51) Int. Cl. H04L 12/28

(52) U.S. Cl. 370/395.1; 370/465

(57) ABSTRACT

ABSTRACT The invention relates to the configuration of Network Access Devices (NAD's) and more specifically, to the detection of the type of protocol encapsulation used on an xDSL line for an ATM VC. The steps occurring in the encapsulation autodetection scheme are as follows. First, the protocol settings are configured for the channel. Then, a packet is created according to the protocol and sent. Any replies received within a timeout delay are recorded. If some replies are received in time, then the autodetection for the particular protocol setting is successful and the autodetection scheme can either abort or continue with another protocol setting, if wanted. If no replies are received in time, the autodetection scheme is started over with other protocol settings.

### CROSS-REFERENCE TO RELATED APPLICATION

This application is a continuation-in-part of PCT patent application serial number PCT/CA0/01127, filed on Sep. 29, 2000.

### FIELD OF THE INVENTION

The invention relates to the configuration of Network Access Devices (NAD's) and more specifically, to the detection of the type of protocol encapsulation used on an ATM VC on an xDSL line.

### BACKGROUND OF THE INVENTION

NADs can be connected to many different types of xDSL line configuration. It is therefore necessary to configure the device to use the appropriate configuration prior to using it. In prior art devices, the line configuration is hardcoded in the NAD at manufacturing to facilitate the user installation of the device, or the user has to have the knowledge of how to configure the device in the appropriate manner to work with the user's access provider. Both those solutions have their problems:hardcoding of the device is costly for the manufacturers and does not allow versatility, and most customers do not need to be aware of what encapsulation is being used by the NAD and therefore, do not wish to be directly involved in the configuration of these NADs. These customers would prefer plug-and-play convenience out of the box.

It would therefore be advantageous for both the customer and the manufacturer to provide, in a NAD, an autodetection scheme for the detection of the type of protocol encapsulation to use on the line.

### SUMMARY OF THE INVENTION

Accordingly, an object of the present invention is to provide an efficient and automatic detection scheme for the protocol encapsulation on a Virtual Channel.

It is another object of the present invention to improve the end-user's experience by providing “out of the box” plug-and-play convenience in the NAD without requiring extensive user intervention.

According to a first broad aspect of the present invention, a method for determining an ATM encapsulation type and a connection type is provided for configuring a Customer Premises Equipment (CPE) Network Access Device (NAD) to use an encapsulation protocol for traffic between the NAD and the remote Network Access Concentrator (NAC) over an ATM link. The method comprises: assembling a first message to solicit a first response according to a first encapsulation protocol; sending the first message over the ATM link to the network access concentrator from the network access device; receiving and recording a first response to the first message at the network access device; analyzing the first response to determine the encapsulation type and connection type to correspond to the first encapsulation protocol using the first message.

Preferably, if a first response to the first message is not received, determines the encapsulation type and connection type to not correspond to the first encapsulation protocol.

Preferably, if a first response to the first message is not received, assembling a second message to solicit a second response according to a second encapsulation protocol, receiving and recording a second response to the second message at the network access device; analyzing the second response to determine the encapsulation type and connection type to correspond to the second encapsulation protocol using the second message.

Preferably, if a second response to the second message is not received, continuing to assemble other messages to solicit other responses according to other encapsulation protocols, receiving and recording other responses to the other messages at the network access device; analyzing the other responses to determine the encapsulation type and connection type to correspond to the other encapsulation protocols using the other messages until a response to one of the other messages is received.

Preferably, the encapsulation type and connection type are determined to correspond to an encapsulation protocol.

Preferably, the encapsulation type and the connection type is at least one of: Routed IP over ATM LLC, PPP over Ethernet over ATM LLC, IP over Ethernet over ATM LLC, PPP over ATM LLC, Routed IP over ATM for VC muxed, PPP over Ethernet over ATM for VC muxed, IP over Ethernet over ATM for VC muxed and PPP over ATM for VC muxed.

Preferably, the first, second and other messages are at least one of DHCP Discover, PPPoE Active Discovery Initiation, PPP Configure Request, IGMP group query, ICMP subnet information request, ICMP information request, ICMP router solicitation, ICMP echo with bad source or destination address, PPP Configure-Ack, PPP Configure-Nak, PPP Terminate-Request, PPP Terminate-Ack, PPP packet with an unknown code, PPP Echo-Request.

Preferably, the first, second and other responses are at least one of DHCP Offer, PPPoE Active Discovery Offer, PPP Terminate Request, a valid PPP response, IGMP group reply, ICMP information reply, ICMP router information reply, ICMP host unreachable message.

According to a second broad aspect of the present invention, a method for determining an ATM encapsulation type and a connection type is provided for configuring a Customer Premises Equipment (CPE) Network Access Device (NAD) to use an encapsulation protocol for traffic between the NAD and the remote Network Access Concentrator (NAC) over an ATM link. The method comprises assembling a plurality of messages to respectively solicit a plurality of responses according to a plurality of respective encapsulation protocols having a common connection type; sending the plurality of messages over the ATM link to the network access concentrator from the network access device; receiving and recording at least one response to the plurality of messages at the network access device; analyzing at least one response to determine the encapsulation type and connection type to correspond to at least one of the respective encapsulation protocols.

According to a third broad aspect of the present invention, there is provided a system for configuring a Customer Premises Equipment (CPE) Network Access Device (NAD) to use an encapsulation protocol comprising an ATM encapsulation type and a connection type for traffic between the NAD and the remote Network Access Concentrator (NAC) over an ATM link. The system comprises: a protocol configurator for setting the NAD to use a first encapsulation protocol; a packet generator for assembling a first message to solicit a first response according to the first encapsulation protocol, sending the first message over the ATM link to the network access concentrator from the network access device and receiving and recording a first response to the first message at the network access device; the protocol configurator analyzing the first response to determine the encapsulation type and connection type to correspond to the first encapsulation protocol using the first message.

Preferably, the system further comprises a user interface for displaying the encapsulation type and the connection type to a user of the system.

Preferably, the system comprises an autodetection configuration for determining parameters for the packet generator to use when assembling the first message.

According to a fourth aspect of the present invention, a computer program comprising code means adapted to perform all steps of the method, embodied on a computer readable medium.

According to a fifth aspect of the present invention, a computer program comprising means adapted to perform all steps of the method, embodied as an electrical or electro-magnetical signal.

For the purpose of the present invention, the following terms are defined below.

The term “Digital Subscriber Line (xDSL)” is intended to mean the family of Digital Subscriber Line technologies, which currently includes ADSL, HDSL, HSDL2, IDSL, SDSL, SHDSL.

The term “Digital Subscriber Line Access Multiplexor (DSLAM)” is intended to mean the xDSL line terminating equipment at the CO.

The term “ML5” is intended to mean the ATM Adaptation Layer.

The term “PPPoE” is intended to mean PPP over Ethernet.

The term “ATM LLC” is intended to mean the Logical Link Control of the ATM.

The term “ATM VC” is intended to mean the Virtual Channel, that is the logical ATM flow over a physical link, one link can support over 16 million VC's.

The term “Virtual Path (VP)” is intended to mean a logical ‘bundle’ of VC's over a physical link, one link can support up to 256 VP's (VPI=0 to 255).

The term “Virtual Path Indicator (VPI)” is intended to mean the first 8 bits of a VP or VC's address.

The term “Virtual Channel Indicator (VCI)” is intended to mean the last 16 bits of a VC address.

The term “ATM/SAR” is intended to mean the segmentation and re-assembly layer of the ATM protocol suite.

The term “DHCP” is intended to mean the Dynamic Host Configuration Protocol.

The term “IPv4” is intended to mean the current version of the Internet Protocol, that is version 4.

The term “Network Access Device” is intended to mean any network modem, bridge or router capable of connecting to a remote network across an ATM-enabled connection (including xDSL lines such as ADSL and SHDSL).

The term “Network Access Concentrator (NAC)” is intended to mean any remote multi-ATM line terminating/concentrating equipment (for the case of xDSL, this corresponds to DSLAM's).

### BRIEF DESCRIPTION OF THE DRAWINGS

These and other features, aspects and advantages of the present invention will become better understood with regard to the following description and accompanying drawings wherein:

FIG. 1 is a block diagram of the main components of the system;

FIG. 2 is a block diagram of the preferred embodiment of the present invention;

FIG. 3 illustrates the possible protocol layering in the present invention;

FIG. 4 illustrates the detailed encapsulation paths to be detected;

FIG. 5 illustrates the relationship between the encapsulations and the layers;

FIG. 6A illustrates the architecture of the initial state before any protocol stack is activated;

FIG. 6B illustrates the architecture of the enabling of the autodetection protocol stack and the connection;

FIG. 6C illustrates the architecture of the enabling of the appropriate protocol stack and the connection that reflects the choice of encapsulation; and

FIG. 7 is a flow chart of the detailed steps of the preferred embodiment.

### DETAILED DESCRIPTION OF THE PREFERRED EMBODIMENT

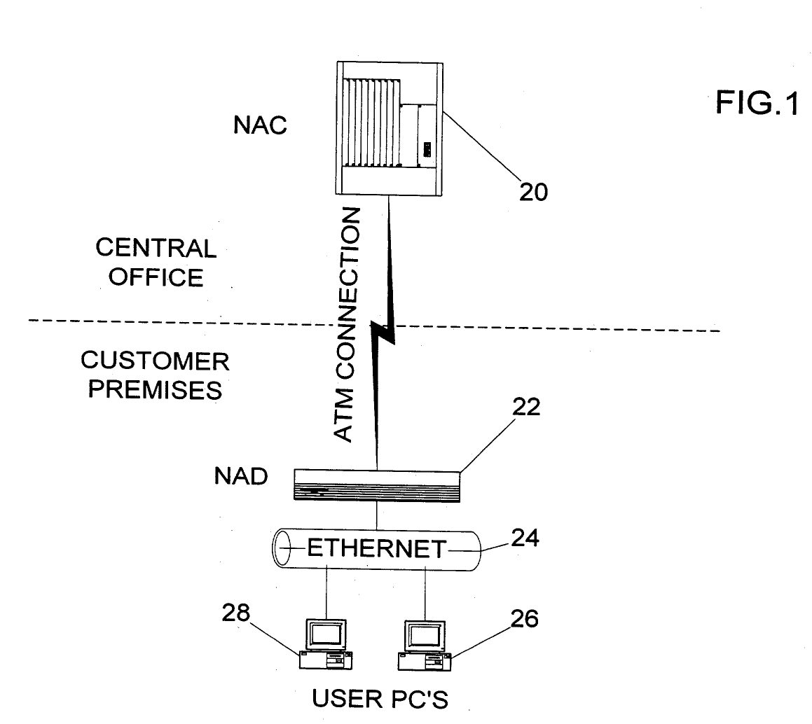

As shown in FIG. 1, the NAC equipment 20 located at the Central Office is accessible to users 28 and 26 through a NAD 22. The users 28 and 26 are connected, using network cards, to an Ethernet network 24, which in turn is connected to the NAD 22.

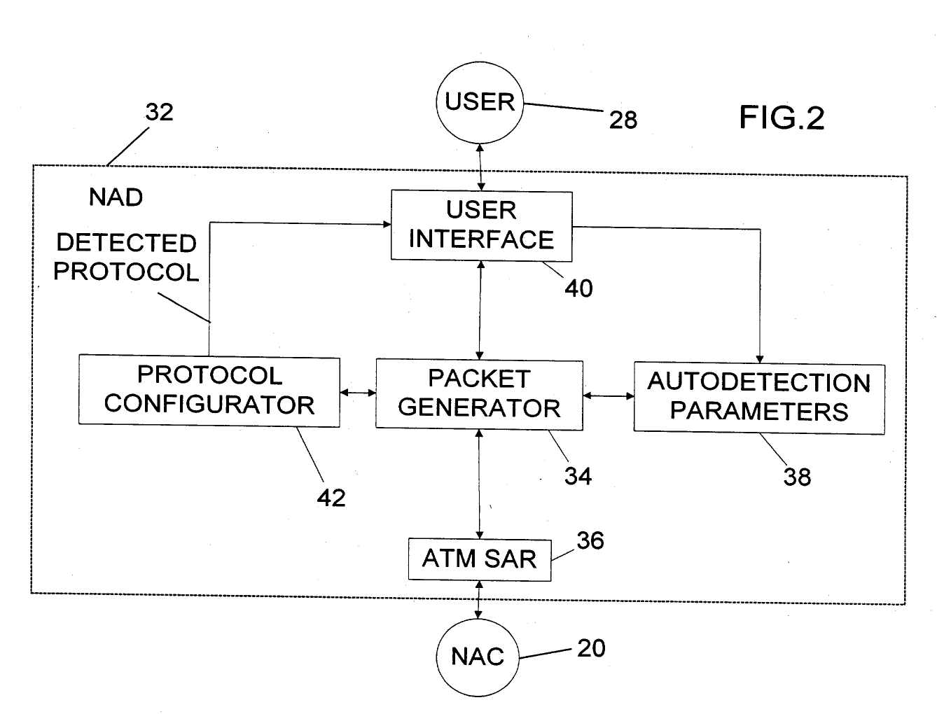

In FIG. 2, the NAD's auto encapsulation detection module is shown in detail as a block diagram. This module functions independently of the regular operations carried out by the NAD. This module can be started by a number of user actions such as connecting the NAD to the network (auto start), or by accessing the user interface (manual start).

The user 28 accesses the NAD's auto encapsulation detection module 32 through a user interface 40. In turn, the NAD is connected to the NAC 20 via the ATM SAR module 36. A packet generator 34 is used to create packets according to a specific protocol to be tested. The packet generator 34 uses default or user-modified autodetection parameters 38 to create the packets. It sends the packets created to the ATM SAR 36 to be sent to the NAC 20. If a reply is sent back to the NAD auto encapsulation detection module 32 by the NAC 20, it is received by the ATM SAR 36 and communicated to the packet generator 34 which recognizes the protocol used in the reply. Default autodetection parameters are stored in the autodetection parameters module 38 at manufacturing and user-modified parameters are entered by the user 28 using the user interface 40. The information concerning a protocol to be tested is given to the packet generator 34 by the protocol configurator 42. The protocol configurator has a list of protocols to be tested and potentially used and contains an algorithm to test them. Once it has detected a valid protocol of encapsulation using the information communicated back from the packet generator 34, it communicates it to the user interface 40.

In order to follow the sequence of events generated by the auto encapsulation detection module, it is necessary to know how the tools used to carry out a few key steps are used. The preferred embodiment of the present invention makes use of the following tools: DHCP Discover, DHCP Offer, PPPoE Active Discovery Initiation, PPPoE Active Discovery Offer, PPP Configure Request, PPP Terminate Request and others. Reference is made herein to the following “Requests for comments (RFC)” which describe these functions: RFC 2131 “Dynamic Host Configuration Protocol” (DHCP), RFC 1661, “The Point-to-Point Protocol (PPP)”, RFC 2364, “PPP Over AAL5”, RFC 2516, “A Method for Transmitting PPP Over Ethernet (PPPoE)” and RFC 2684, “Multiprotocol Encapsulation over ATM AAL5”. Other RFCs cover the ICMP and IGMP protocols.

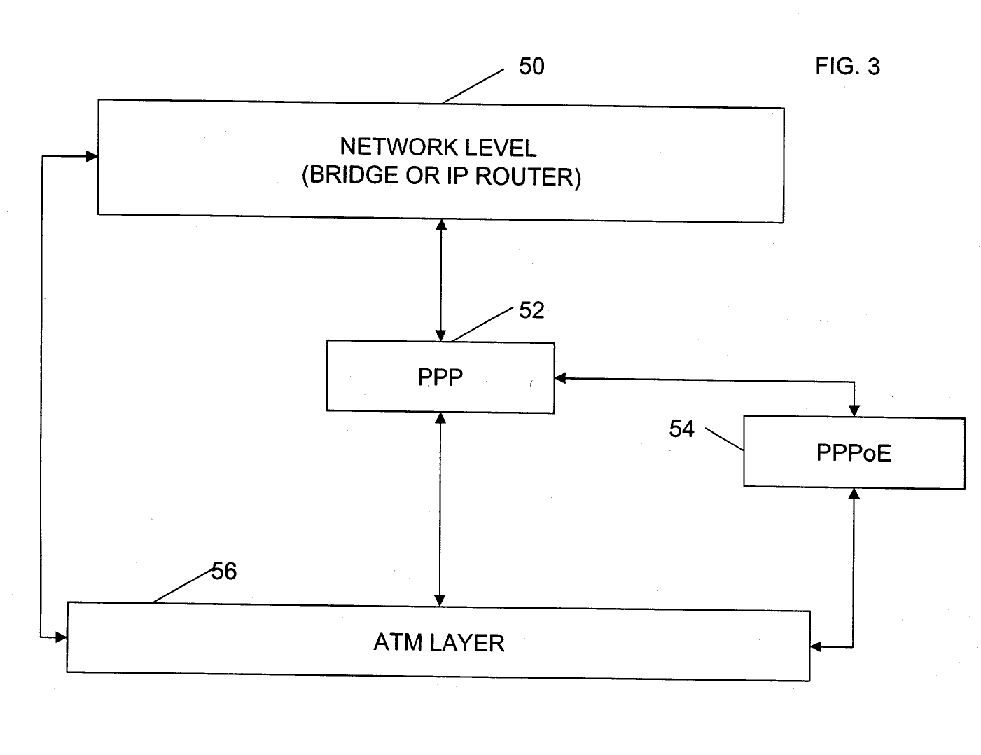

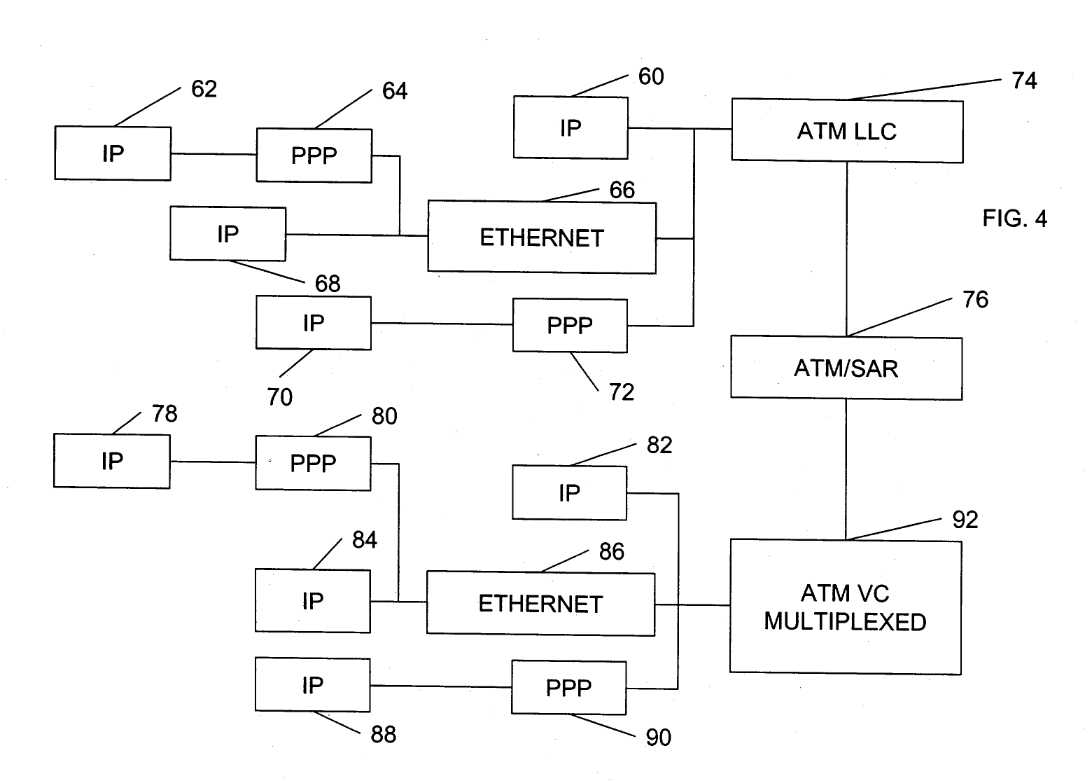

FIG. 3 illustrates the possible protocol layering in a NAD. The Bridged Ethernet over AAL-5 or routed IP over ML5 corresponds to the link between the Network Level 50, and the ATM layer 56. This link also corresponds to the paths Routed IP 60 over ATM LLC 74, IP 68 over Ethernet 66 over ATM LLC 74, Routed IP 82 over ATM for VC muxed 92 and IP 84 over Ethernet 86 over ATM for VC muxed 92 of FIG. 4. The link between the Network Level (Bridge or IP Router) 50, the PPP 52 and the ATM Layer 56 is the PPP over ATM. It corresponds to the paths PPP 72 over ATM LLC 74 and PPP 90 over ATM for VC muxed 92 of FIG. 4. The link between the Network Level (Bridge or IP Router) 50, the PPP 52, the PPPoE 54 and the ATM Layer 56 is the PPP over Ethernet over ATM. It corresponds to the paths PPP 64 over Ethernet 66 over ATM LLC 74 and PPP 80 over Ethernet 86 over ATM for VC muxed 92 of FIG. 4.

Referring now to FIG. 4, it is illustrated the different types of encapsulation supported by the typical NADs. An algorithm describing the preferred embodiment for each of these paths will be described. It should be noted that it is assumed that the AAL5 layer is able to change its encapsulation in real time, while the layer is connected. The different types of encapsulation supported are as follows:

Routed IP 60 over ATM LLC 74

PPP 64 over Ethernet 66 over ATM LLC 74

IP 68 over Ethernet 66 over ATM LLC 74

PPP 72 over ATM LLC 74

Routed IP 82 over ATM for VC muxed 92

PPP 80 over Ethernet 86 over ATM for VC muxed 92

IP 84 over Ethernet 86 over ATM for VC muxed 92

PPP 90 over ATM for VC muxed 92

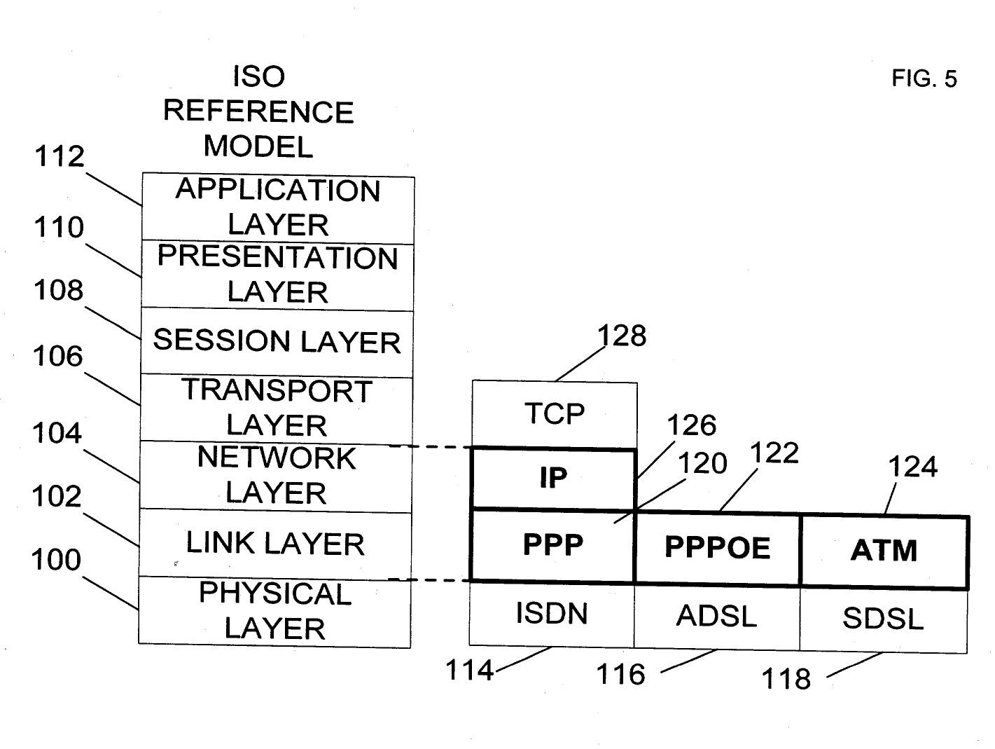

Referring now to FIG. 5, it is shown the relationship between the different protocols and the ISO layers. The algorithms presented herein are aimed at detecting the protocols used on the network layer 104 and on the link layer 102, i.e. IP 126, PPP 120, PPPoE 122 and ATM 124. The protocols on the other layers are not detected by the present invention.

The following algorithms are examples of methods that can be used to detect particular paths and therefore, particular encapsulations.

Routed IP 60 over ATM LLC 74

1. The Protocol Configurator 42 configures the chosen ATM VC for routed IPv4 encapsulation.

2. The Packet Generator 34 creates a DHCP DISCOVER message and sends it to ATM SAR 36 to be sent to the NAC 20.

3. The Packet Generator 34 waits a number of seconds to receive a DHCP OFFER message from the NAC 20 through the ATM SAR 36. A timeout of 5 seconds has been shown to be efficient.

4. If a DHCP OFFER is received by NAD 22 and the Packet Generator 34 in step 3 then this encapsulation has been detected and a message is sent to the protocol configurator 42 to stop the autodetection process. A message is then sent to the user interface 40 by the protocol configurator 42.

This algorithm assumes that there is a DHCP server at the Central Office and that a DHCP discovery request will be answered to.

PPP over Ethernet over ATM LLC

1. The Protocol Configurator 42 configures the chosen ATM VC for Bridged Ethernet encapsulation.

2. The Packet Generator 34 creates a PPPoE Active Discovery Initiation (PADI) packet and sends it to ATM SAR 36 to be sent to the NAC 20.

3. The Packet Generator 34 waits a number of seconds to receive a PPPoE Active Discovery Offer (PADO) packet from the NAC 20 through the ATM SAR 36. A timeout of 5 seconds has been shown to be efficient.

4. If a PADO packet is received by NAD 22 and the Packet Generator 34 in step 3 then this encapsulation has been detected and a message is sent to the protocol configurator 42 to stop the autodetection process. A message is then sent to the user interface 40 by the protocol configurator 42.

IP over Ethernet over ATM LLC

1. The Protocol Configurator 42 configures the chosen ATM VC for Bridged Ethernet encapsulation.

2. The Packet Generator 34 creates a DHCP DISCOVER message encapsulated in an Ethernet packet and sends it to ATM SAR 36 to be sent to the NAC 20.

3. The Packet Generator 34 waits a number of seconds to receive any Ethernet/IP packet from the NAC 20 through the ATM SAR 36. A timeout of 5 seconds has been shown to be efficient.

4. If a DHCP OFFER is received by NAD 22 and the Packet Generator 34 in step 3 then this encapsulation has been detected and a message is sent to the protocol configurator 42 to stop the autodetection process. A message is then sent to the user interface 40 by the protocol configurator 42.

PPP over ATM LLC

1. The Protocol Configurator 42 configures the chosen ATM VC for PPP encapsulation.

2. The Packet Generator 34 creates a PPP Configure-Request containing an unknown option and sends it to ATM SAR 36 to be sent to the NAC 20.

3. The Packet Generator 34 waits a number of seconds to receive any PPP packet from the NAC 20 through the ATM SAR 36. A timeout of 5 seconds has been shown to be efficient.

4. If a PPP packet is received by NAD 22 and the Packet Generator 34 in step 3 then this encapsulation has been detected and a message is sent to the protocol configurator 42 to stop the autodetection process. A message is then sent to the user interface 40 by the protocol configurator 42. Construct and send a PPP Terminate-Request to cleanly terminate the PPP session.

Path Routed IP 82 over ATM for VC muxed 92, PPP 80 over Ethernet 86 over ATM for VC muxed 92, IP 84 over Ethernet 86 over ATM for VC muxed 92 and PPP 90 over ATM for VC muxed 92

Same as Routed IP 60 over ATM LLC 74, PPP 64 over Ethernet 66 over ATM LLC 74, IP 68 over Ethernet 66 over ATM LLC 74 and PPP 72 over ATM LLC 74 respectively but configure the chosen ATM for VC muxed.

Alternate methods of discovering paths Routed IP 60 over ATM LLC 74 and

Routed IP 82 over ATM for VC muxed 92 With the exception of the Routed method described below, all of these alternate methods have the property that the source IP address can either be invalid or simply specified as ‘local network’ (0.0.0.0), and the destination address is either broadcast (255.255.255.255) or multicast (124.0.0.12). The success of these methods depends largely on how the remote end router's IP protocols are implemented.

IGMP group query

requests membership in the local multicast group

ICMP subnet information request

requests local network subnet address information

ICMP information request

requests local network address information

ICMP router solicitation

requests self address information

ICMP echo with bad source or destination address

the intention here is to code the packet so that it will elicit an ICMP “packet undeliverable” error message from the remote router.

Routed with valid (non-local) source/destination addresses

the intention here is to code the packet so that it will elicit an ICMP “packet timed out” error message from the remote router. It can be either a routed UDP or TCP packet.

If any of these packets elicit a response of a valid IP packet from the remote IP stack, then it would be considered a conclusive detection of the IP protocol at the other end.

It would be possible to use such techniques in the event that the DHCP-discover method does not elicit a response.

Alternate methods of discovering paths PPP 72 over ATM LLC 74 and PPP 90 over ATM for VC muxed 92

In addition to the preferred technique specified above, here are other techniques for detecting the presence of PPP at the other end:

In essence, any packet which elicits a response packet from the remote NAC PPP implementation is a good detection technique. The packets that can elicit such a response can be deduced from RFC 1661 finite state machine, which is incorporated herein by reference.

Therefore, in addition to sending a PPP Configure-Request with an unknown option, either of the following packets could be sent:

A PPP Configure-Ack

A PPP Configure-Nak

A PPP Terminate-Request

A PPP Terminate-Ack

A PPP packet with an unknown code

A PPP Echo-Request

Any valid PPP packet received after sending one of these packets would be considered a conclusive detection of PPP at the other end.

It should be noted that a message comprising, for example, an IP ping to a known a stable server could also be used to discover if an encapsulation type is supported. It would also be possible for the configuration module to listen to broadcast messages on the channel and extract encapsulation information from these messages.

It is possible to parallelize the detection of all the paths that share a common ATM encapsulation. It is however, not possible to combine the test for 2 paths with a different ATM encapsulation because a packet with the wrong encapsulation will be discarded at the ATM level, and will never reach the autodetection module.

A preferred embodiment of the algorithm to perform parallel detection is as follows:

1. The Packet Generator 34 generates and send packets to detect all of the paths with a common encapsulation to the ATM SAR 36 and the NAC 20.

2. The packet generator 34 waits the configured delay and records any replies to the packets sent.

3. The packet generator 34 reports the encapsulations for which a return packet has been received to the protocol configurator 42 as detected protocols. The protocol configurator 42 makes the proper configuration settings and reports to the user interface 40 with the detected protocol.

When using parallel detection, the paths Routed IP 60 over ATM LLC 74, PPP 64 over Ethernet 66 over ATM LLC 74, IP 68 over Ethernet 66 over ATM LLC 74 and PPP 72 over ATM LLC 74 will need one waiting period, and the paths Routed IP 82 over ATM for VC muxed 92, PPP 80 over Ethernet 86 over ATM for VC muxed 92, IP 84 over Ethernet 86 over ATM for VC muxed 92 and PPP 90 over ATM for VC muxed 92 will need another. This amounts to just 2 waiting periods compared to 8 if all the paths are tested sequentially. Therefore, if a waiting period of 5 seconds is used for each of the detection schemes, a total of 10 seconds will be necessary for the parallel detection instead of the 40 seconds necessary if the detection is done sequentially for each encapsulation.

This encapsulation detection can be repeated for each supported VC and can be done in parallel for all VC's at the same time.

If none of the encapsulation detection algorithms are successful, the customer can communicate with the service provider to obtain the proper encapsulation configuration or can alternatively, start the autodetection scheme again with a longer waiting period in case the replies were not received in time.

To start the autodetection process, the protocol configurator 42 must enable and connect a special protocol stack (not shown) that contains the autodetection, AAL5 and SAR/ADSL layers. It is, preferably, the responsibility of the protocol configurator 42 to configure the AAL5 layer with a valid VP/VCI that was obtained either from the user or a prior VP/VCI autodetection step.

The encapsulation autodetection module 32 reports the following information through the configuration: what state it is in (i.e. Idle, Running, Aborted or Completed) and if it is in the Running, Aborted or Completed state, the list of encapsulations successfully detected.

When it has finished its autodetection, the autodetection layer will inform the protocol configurator 42. At that point the protocol configurator 42 can disable the autodetection protocol stack and then examine and present the encapsulation choices to the user through the user interface 40, by reading the appropriate table in the configuration. After a choice is made by the user, the appropriate protocol stack can be configured and connected.

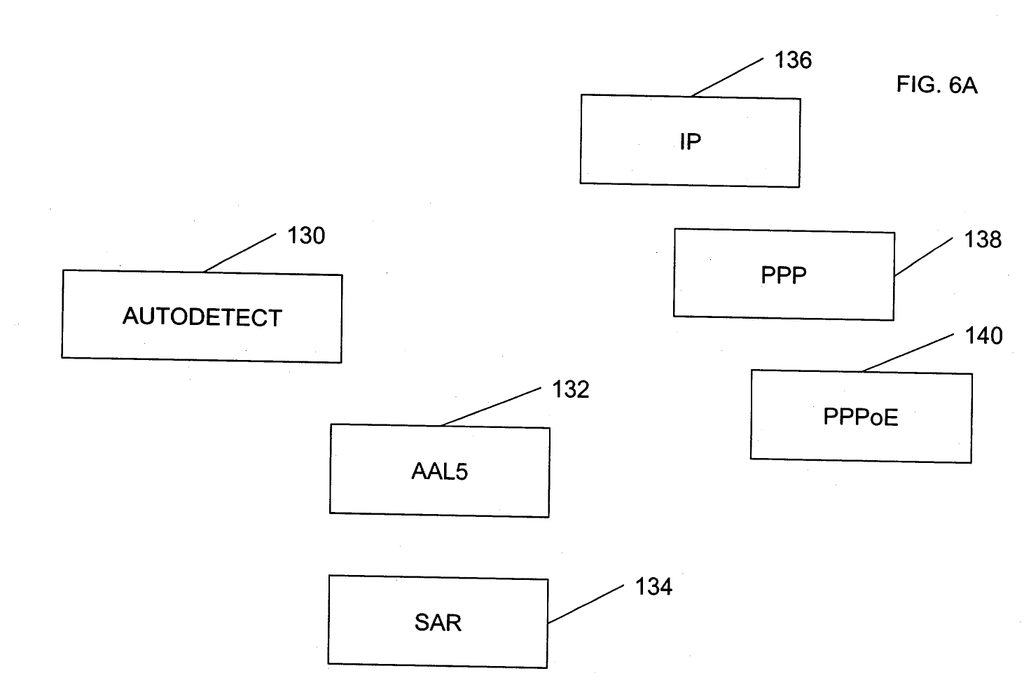

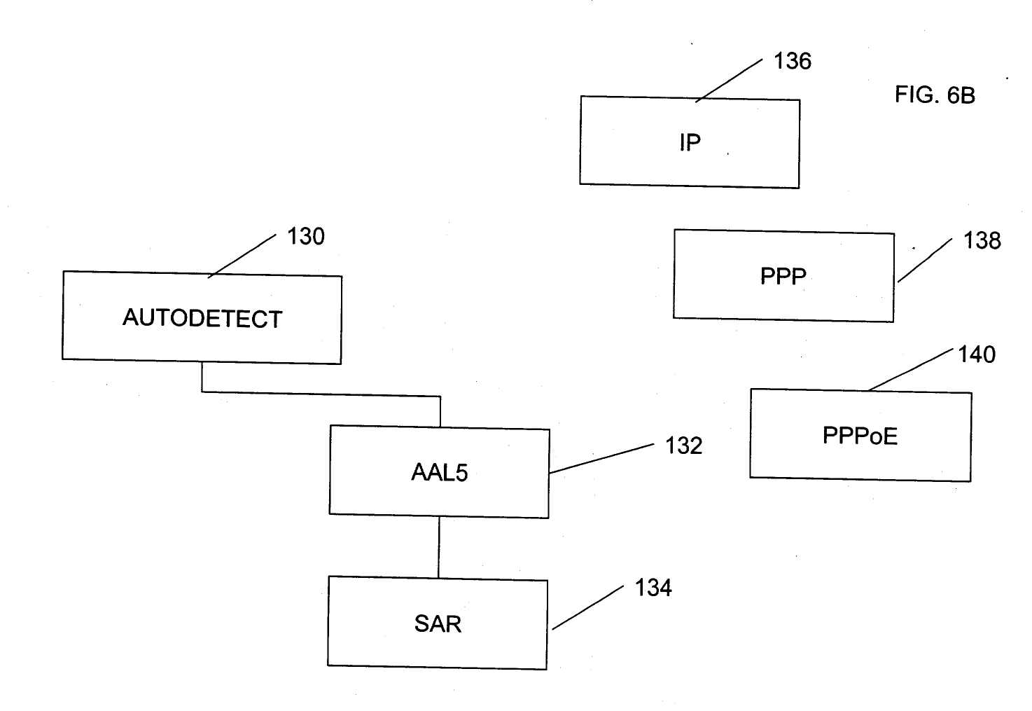

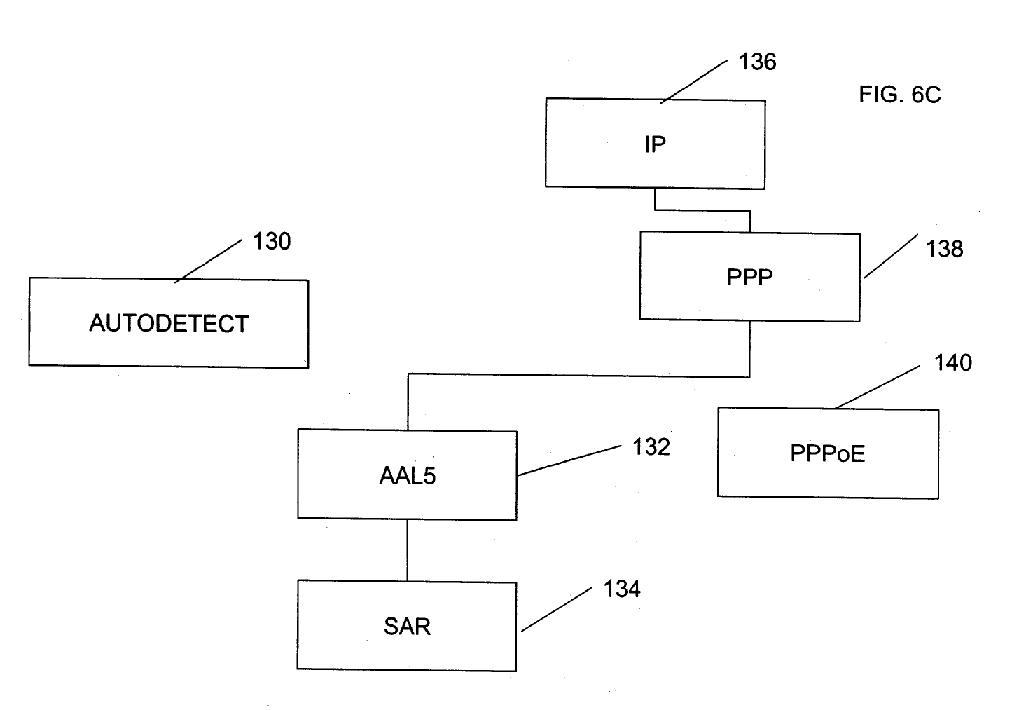

FIGS. 6A, 6B and 6C illustrate the architecture of the autodetection layer. In FIG. 6A, the Initial state before any protocol stack is activated is shown. The IP layer 136, the PPP layer 138, the PPPoE layer 140, the Autodetection layer 130, the AAL5 layer 132 and the SAR layer 134 are shown. In FIG. 6B, the autodetection protocol stack is enabled and connected. A path 131 is created between the autodetection layer 130, the AAL5 layer 132 and the SAR layer 134. In FIG. 6C, the appropriate protocol stack is enabled and connected to reflect the choice of encapsulation. In this example, path 133 is created which links the IP layer 136, the PPP layer 138, the AAL5 layer 132 and the SAR layer 134. This chosen path corresponds to path PPP 72 over ATM LLC 74 of FIG. 4.

A few parameters 38 can be configured in the autodetection module. Such parameters can be: the ATM VC on which to perform the encapsulation autodetection, the types of encapsulation to try to detect, the order in which to test for the encapsulations and how long to wait for an answer packet when testing a configuration.

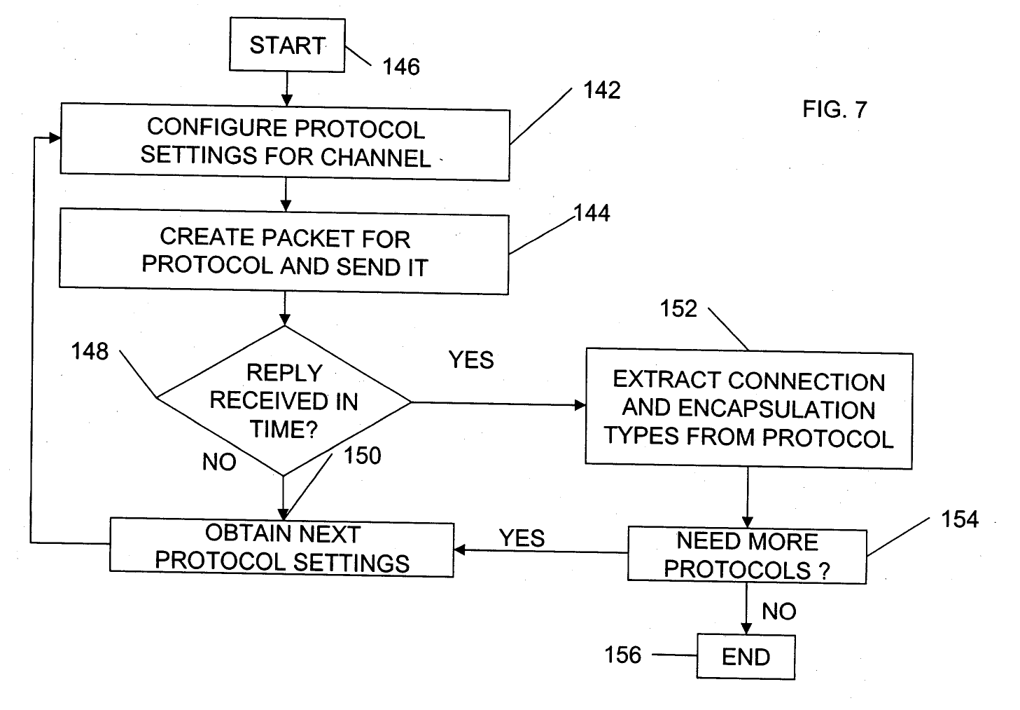

FIG. 7 shows a flow chart of the steps occurring in the encapsulation autodetection scheme. First, the protocol settings are configured for the channel 142. Then, a packet is created according to the protocol and sent 144. Any replies received within a timeout delay are recorded 148. If some replies are received in time 152, then the autodetection for the particular protocol setting is successful, the connection type and encapsulation type is determined from the protocol settings used and the autodetection scheme can either end 156 or continue with another protocol setting 150 if wanted 154. If no replies are received in time 150, the autodetection scheme is started over 142 with other protocol settings 150.

The following is an algorithm which details the steps performed by a User Interface (UI) 40 to manage, present, and request information required to establish a correct connection to the Internet, using the encapsulation autodetection scheme.

The Variables used in the algorithm are as follows:

VC_SELECTED: one VC, selected by the user.
ENCAPS_SELECTED: Contains the encapsulation used for the
connection.
ENCAPS_DETECT: given a VC (VPI/VCI), deterministically detects
possible encapsulation
BEGIN
Launch ENCAPS_DETECT using VC_SELECTED.

Display a “Data link protocol autodetection in progress” screen with,

potentially, a progression bar showing the progress of the autodetection.
If ENCAPS_DETECT found one encapsulation type only
{

Display the detected ATM encapsulation and the detected connection
type. Store the found entry in ENCAPS_SELECTED.
Ask the user to complete the process by entering the connection

settings such as, for example, the IP address, the DNS address of a first
DNS, the DNS address of a second DNS as given to the user by the
Internet Service Provider, a username, a password, etc.
}
else if ENCAPS_DETECT found multiple encapsulation type
{

Display the list of all detected ATM encapsulation and detected

connection types found by ENCAPS_DETECT. Ask the user to select
only one ATM encapsulation and Connection type.

Store the selected one in ENCAPS_SELECTED.
Ask the user to complete the process by entering the connection

settings such as, for example, the IP address, the DNS address of a
first DNS, the DNS address of a second DNS as given to the user by the
Internet Service Provider, a username, a password, etc.
}
else if ENCAPS_DETECT found no encapsulation
{
Suggest a default encapsulation type to the user, and ask the user to
confirm the suggested encapsulation or to specify another one. The choice
of the user is stored in ENCAPS_SELECTED.
}
END
The results are in ENCAPS_SELECTED.

It should be noted that the present invention can be carried out as a method, can be embodied in a system, a computer readable medium or an electrical or electromagnetic signal.

It will be understood that numerous modifications thereto will appear to those skilled in the art. Accordingly, the above description and accompanying drawings should be taken as illustrative of the invention and not in a limiting sense. It will further be understood that it is intended to cover any variations, uses, or adaptations of the invention following, in general, the principles of the invention and including such departures from the present disclosure as come within known or customary practice within the art to which the invention pertains and as may be applied to the essential features hereinbefore set forth, and as follows in the scope of the appended claims.

What is claimed is:

1. In configuring a Customer Premises Equipment (CPE) Network Access Device (NAD) to use an encapsulation protocol for traffic between the NAD and the remote Network Access Concentrator (NAC) over an ATM link, a method for determining an ATM encapsulation type and a connection type comprising:
assembling a first message to solicit a first response according to a first encapsulation protocol;
sending said first message over the ATM link to said network access concentrator from said network access device;
receiving and recording a first response to said first message at said network access device;
analyzing said first response to determine said encapsulation type and connection type to correspond to said first encapsulation protocol using said first message.

2. A method as claimed in claim 1, further comprising, if a first response to said first message is not received, determining said encapsulation type and connection type not to correspond to said first encapsulation protocol.

3. A method as claimed in claim 1, further comprising, if a first response to said first message is not received,
assembling a second message to solicit a second response according to a second encapsulation protocol,
receiving and recording a second response to said second message at said network access device;
analyzing said second response to determine said encapsulation type and connection type to correspond to said second encapsulation protocol using said second message.

4. A method as claimed in claim 3, further comprising, if a second response to said second message is not received,
continuing to assemble other messages to solicit other responses according to other encapsulation protocols,
receiving and recording other responses to said other messages at said network access device;
analyzing said other responses to determine said encapsulation type and connection type to correspond to said other encapsulation protocols using said other messages until a response to one of said other messages is received.

5. A method as claimed in claim 2, wherein said encapsulation type and connection type are determined to correspond to a second encapsulation protocol.

6. A method as claimed in claim 1, wherein said encapsulation type and said connection type is at least one of Routed IP over ATM LLC, PPP over Ethernet over ATM LLC, IP over Ethernet over ATM LLC, PPP over ATM LLC, Routed IP over ATM for VC muxed, PPP over Ethernet over ATM for VC muxed, IP over Ethernet over ATM for VC muxed and PPP over ATM for VC muxed.

7. A method as claimed in claim 1, wherein said first, second and other messages are at least one of DHCP Discover, PPPoE Active Discovery Initiation, PPP Configure Request, IGMP group query, ICMP subnet information request, ICMP information request, ICMP router solicitation, ICMP echo with bad source or destination address, PPP Configure-Ack, PPP Configure-Nak, PPP Terminate-Request, PPP Terminate-Ack, PPP packet with an unknown code, PPP Echo-Request.

8. A method as claimed in claim 1, wherein said first, second and other responses are at least one of DHCP Offer, a valid IP packet, PPPoE Active Discovery Offer, PPP Terminate Request, a valid PPP response, IGMP group reply, ICMP information reply, ICMP router information reply, ICMP host unreachable message.

9. In configuring a Customer Premises Equipment (CPE) Network Access Device (NAD) to use an encapsulation protocol for traffic between the NAD and the remote Network Access Concentrator (NAC) over an ATM link, a method for determining an ATM encapsulation type and a connection type comprising:
assembling a plurality of messages to respectively solicit a plurality of responses according to a plurality of respective encapsulation protocols having a common connection type;
sending said plurality of messages over the ATM link to said network access concentrator from said network access device;
receiving and recording at least one response to said plurality of messages at said network access device;
analyzing said at least one response to determine said encapsulation type and connection type to correspond to at least one of said respective encapsulation protocols.

10. A system for configuring a Customer Premises Equipment (CPE) Network Access Device (NAD) to use an encapsulation protocol comprising an ATM encapsulation type and a connection type for traffic between the NAD and the remote Network Access Concentrator (NAC) over an ATM link, the system comprising:
a protocol configurator for setting the NAD to use a first encapsulation protocol;
a packet generator for assembling a first message to solicit a first response according to said first encapsulation protocol, sending said first message over the ATM link to said network access concentrator from said network access device and receiving and recording a first response to said first message at said network access device;
said protocol configurator analyzing said first response to determine said encapsulation type and connection type to correspond to said first encapsulation protocol using said first message.

11. A system as claimed in claim 10, further comprising a user interface for displaying said encapsulation type and said connection type to a user of said system.

12. A system as claimed in claim 10, further comprising an autodetection configurator for determining parameters for said packet generator to use when assembling said first message.

13. A computer program comprising code means adapted to perform all steps of claim 1, embodied on a computer readable medium.

14. A computer program comprising code means adapted to perform all steps of claim 1, embodied as an electrical or electro-magnetical signal.

15. A computer program comprising code means adapted to perform all steps of claim 9, embodied on a computer readable medium.

16. A computer program comprising code means adapted to perform all steps of claim 9, embodied as an electrical or electro-magnetical signal.

17. A computer program comprising code means adapted to, when loaded in a computer, embody the system of claim 10, embodied on a computer readable medium.

18. A computer program comprising code means adapted to, when loaded in a computer, embody the system of claim 10, embodied as an electrical or electro-magnetical signal.
